(19) United States
(12) Patent Application Publication
(10) Pub. No.: US 2012/0278161 A1
(43) Pub. Date: Nov. 1, 2012

(54) Co-Mingling System for Delivery of Advertising and Corresponding Methods

(76) Inventor: William P. Lazzaro, Rocky River, OH (US)

(21) Appl. No.: 13/096,921

(22) Filed: Apr. 28, 2011

(51) Int. Cl. G06Q 30/00

(52) U.S. Cl. 705/14.45; 705/14.49

(57) ABSTRACT

A system (100,300) and method (500,600) for delivering advertising selected for a target audience to the target audience are disclosed. The system (100,300) includes an advertising selector (206,306) configured to select one or more advertisements (114,314), which may be interactive and include click-through interaction features (315). The advertisements (114,314) are delivered to user devices (106,107,108,306,307,308) of members of an audience. A detector (208,408) is configured to determine a usage rate, and to detect whether predetermined thresholds for usage were met. Where they were not, a database-mining engine (209,409) determines one or more additional content offerings where at least a portion of the usage set of members was co-mingled, and to then determine one or more future content offerings corresponding thereto. An advertising placement opportunity generator (214,414) then schedules advertisements to be delivered during the future content offerings.

### BACKGROUND

1. Technical Field

This invention relates generally to an advertisement delivery system and method, and more particularly to a system and method for delivering advertising to an audience.

2. Background Art

The technology associated with video content delivery is rapidly advancing. Not too long ago, the only way for consumers to view video content was by receiving television signals through the air or by going to the movies. Now, however, a person can watch video on a variety of devices, including televisions, computers, and even smart phones. Additionally, with systems like video on demand, they can selectively order specific content and then view it at the time and place of their choosing.

Prior art advertising systems with video content have generally been limited. With prior art systems an advertiser must select a show in which to purchase advertising space. The advertiser's advertisement is then broadcast to all viewers of that show. While this can be an effective method of advertising, it precludes the advertiser from effectively reaching a target audience. For example, if an advertiser picks a racing program during which to advertise fishing gear, the advertiser must hope that a large number of racing fans also like fishing. If they do, great. If not, the advertiser's money has been wasted. This hit-or-miss, broadcast method is frequently a less than efficient means of achieving the advertiser's goal of creating an effective advertisement and placing that advertisement before an audience likely to be motivated by the advertisement.

It would be advantageous to have a more effective advertising delivery system.

### BRIEF DESCRIPTION OF THE DRAWINGS

FIG. 1 illustrates one system for delivering advertising selected for a target audience configured in accordance with one or more embodiments of the invention.

FIG. 2 illustrates one server system suitable for use with a system for delivering advertising selected for a target audience configured in accordance with one or more embodiments of the invention.

FIG. 3 illustrates one system for delivering advertising selected for a target audience configured in accordance with one or more embodiments of the invention.

FIG. 4 illustrates one server system suitable for use with a system for delivering advertising selected for a target audience configured in accordance with one or more embodiments of the invention.

FIG. 5 illustrates one method for delivering advertising selected for a target audience configured in accordance with one or more embodiments of the invention.

FIG. 6 illustrates one method for delivering advertising selected for a target audience configured in accordance with one or more embodiments of the invention.

FIG. 7 illustrates an exemplary use case in accordance with one or more embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF EMBODIMENTS OF THE INVENTION

Before describing in detail embodiments that are in accordance with the present invention, it should be observed that the embodiments reside primarily in combinations of method steps and apparatus components related to targeted advertising delivery systems and methods, such as those employing one or more servers in a video-content delivery system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of targeted advertising delivery described herein. The non-processor circuits may include, but are not limited to, network communication devices, routers, switches, video compression and decompression engines, and user devices. As such, these functions may be interpreted as steps of a method to perform targeted advertising delivery as described herein. It is expected that one of ordinary skill, notwithstanding possibly significant effort and many design choices motivated by, for example, available time, current technology, and economic considerations, when guided by the concepts and principles disclosed herein will be readily capable of generating such systems and methods with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present invention provide a system and method for delivering advertising to audience members with a co-mingled correlation to a target audience. In one embodiment, a database-mining engine, which is operable with a content delivery server, is configured to work with one or more databases to determine new prospective content when advertising targets are initially missed.

The targets can take many forms, as embodiments of the invention can be configured in various ways. Generally speaking, a target represents one or more criteria that form a decision basis for determining whether to execute one or more co-mingling data mining operations. The co-mingling data mining operations are executed to determine new prospective content when an initial target is missed. A few examples of targets are discussed below for illustration. It will be clear to those of ordinary skill in the art having the benefit of this disclosure that other targets could also be used, and that the illustrative list below is not to be limiting.

In a first embodiment, where user devices can be interactively queried, the target can comprise a minimum threshold of the user devices that actually present the advertisement to a user. Said differently, when user devices can be queried to determine whether the advertisement was actually presented to a user, the target can be a minimum number of actual advertisement presentations. Accordingly, when a number of user devices presenting the targeted advertisement to the user is below the minimum threshold, the co-mingling data mining operations can be executed to determine new prospective content where actual presentations will be higher. Such an embodiment works regardless of the type of advertising being delivered.

In a second embodiment, the advertisement is interactive. One example of an interactive advertisement is a “click-through” advertisement. “Click-through” advertising refers to embodiments described herein employing interactive digital advertisement insertion where the viewer can select, or “click,” an option to view additional content when an interactive digital advertisement is included with content. Where the user clicks “yes,” additional content related to the advertisement is delivered. Where the user clicks “no,” the advertisement is dismissed. In these embodiments, click-through rates can be determined by the concentration of viewers who positively click-through an advertisement.

Where “click-through” advertising is used, the criteria forming the basis for executing the co-mingling data mining operations can be a predetermined “click-through” rate, or, a minimum number of click-through interactions that occur. The co-mingling data mining operations can be executed to determine new prospective content when a prior click-through rate, occurring when the targeted advertising was delivered, fell below a predetermined click-through threshold. The co-mingling data mining operations are executed to find new content where the click-through rate will be substantially higher. The database mining engine can be configured to execute a method for determining potential future content into which interactive advertisements may be inserted based upon like subscribers who have previous linear viewership within predetermined usage windows.

When interactive advertising is employed, the criteria forming the basis of the decision to execute the co-mingling data mining operations can vary. In a first interactive advertising embodiment, when initial click-through targets are missed the data-mining engine can search for alternate content back in time for high co-mingling of users who positively clicked-through advertisements and can then suggest similar content to achieve higher click-through rates in the future. In a second interactive advertising embodiment, when a click-through target is met but a minimum click threshold is not met, the data-mining engine can search for alternate content back in time for high co-mingling of users who positively clicked-through advertisements and can then suggest similar content to achieve higher click-through rates in the future. In a third interactive advertising embodiment, when a predetermined minimum number of click-through interactions is not met, the data-mining engine can search for alternate content back in time for high co-mingling of users who positively clicked-through advertisements and can then suggest similar content to achieve higher click-through rates in the future Accordingly, embodiments described herein allow advertisers to increase overlay exposure and success by targeting users having similar viewership patterns.

Embodiments of the invention can be configured to work with any number of content delivery systems. Examples include video-on-demand systems, broadcast systems employing interactive user devices, terrestrial systems such as cable content delivery systems employing interactive user devices, computer systems such as content delivery through wide area and/or local area networks including the Internet, cellular systems, satellite systems, telco systems, HFS systems, POTS systems, a wide-area, local-area, or Internet Protocol-based video content delivery system, and so forth. For simplicity of discussion, a generalized video content delivery system will be used herein to illustrate how the co-mingling data mining operations occur in accordance with one or more embodiments of the invention. However, it will be clear to those of ordinary skill in the art having the benefit of this disclosure that the system component, method steps, and apparatus components described herein can readily be adapted to fit any number of network species without undue experimentation. Where necessary, specific examples of certain types of systems will be provided in the general discussion that follows.

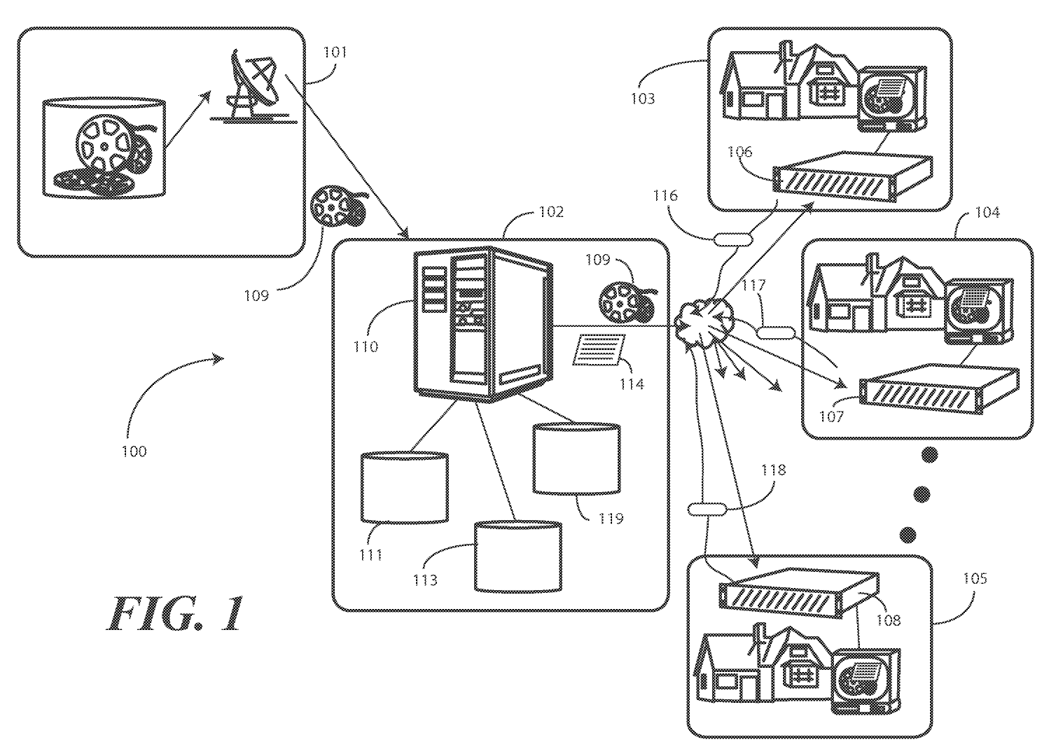

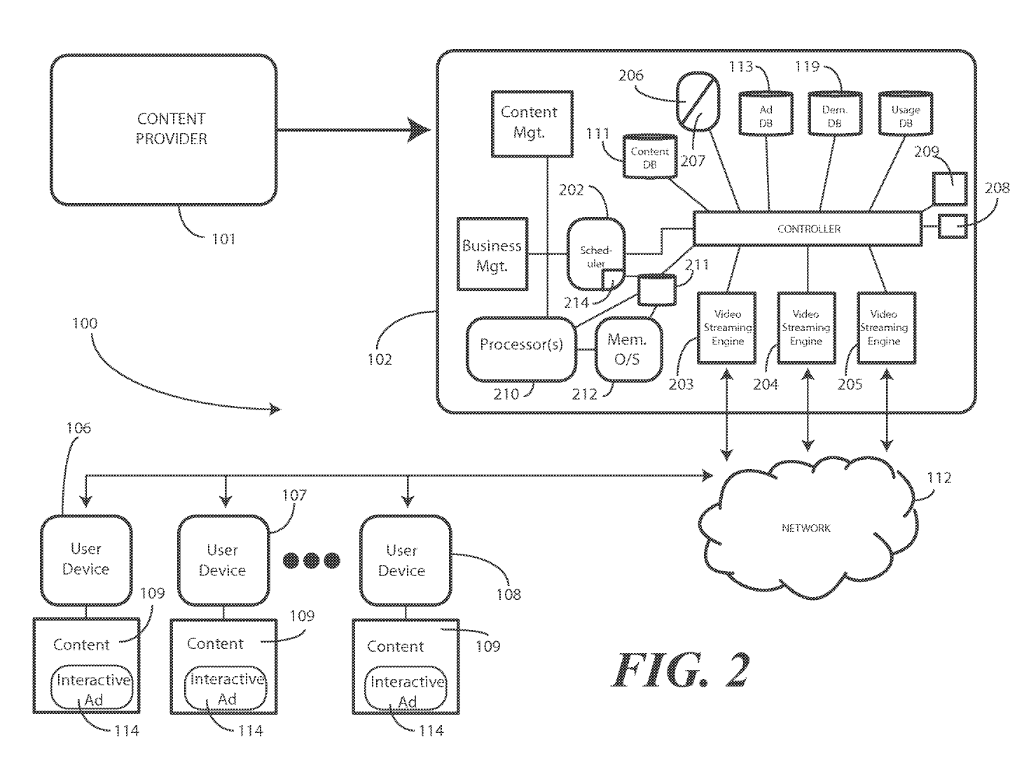

Turning now to FIGS. 1 and 2, illustrated therein is a first embodiment of the invention suitable for use with generic advertising. The system 100 of FIG. 1 is configured for delivering advertising to a target audience. FIG. 1 illustrates a macro-level view of the system 100, while FIG. 2 includes a block diagram illustrating components of a server complex 102. The system 100 of FIGS. 1 and 2 is suitable for implementing the methods of delivering advertising content described below.

In one embodiment, the system 100 is configured for delivering video content offerings to one or more users 103,104,105. The general components of the system 100 include one or more content providers 101 who create or originate content, a server complex 102 configured for content distribution, and one or more users 103,104,105 who receive content.

Each of the users 103,104,105 has a corresponding user device 106,107,108 configured to receive content 109. Examples of user devices 106,107,108 occurring in various environments include a television, set-top-box, personal computer, laptop, smartphone, tablet computer, personal digital assistant, handheld computer, cellular telephone, or the like.

In one illustrative embodiment, the server complex 102 is capable of interaction with the user devices 106,107,108. For example, the server complex 102 may be configured to determine what content each user device 106,107,108 is receiving, and whether the content is presented to a user. Additionally, the server complex 102 can be configured to determine unique device identifier for each of the user devices 106,107,108 so that the user devices 106,107,108 can be identified on a singular basis. Examples of device identifiers include a MAC address or IP address in a computer environment, a mobile telephone number in a mobile environment, a serial number or other unique identifier in a set-top box environment, and so forth.

The content providers 101 originate content 109 and deliver it to the server complex 102 for distribution to the user devices 106,107,108. The content 109 can be delivered in various formats and protocols, depending upon the type of system employed. For example, the server complex 102 may receive RF signals by satellite, ATM data from ATM networks, local feeds, and other information via terrestrial link. The content providers 101 may also provide the content by traditional means, such as by tape, DVD, or alternatively may transmit digital files across a network.

A content receiver (not shown) operable with the server complex 102 receives the content 109. In one embodiment, the server system 110 then stores the content 109 in a content database 111. In another embodiment, the server system 110 simply passes the content through for distribution to the users 103,104,105 through its network.

In one embodiment, the server system 110 is configured to insert advertisements into the content 109. Where necessary, the server complex 102 can optionally process and/or reformat the content 109 as necessary for delivery to the user devices 106,107,108. For example, content 109 may be received in digitally compressed format, demultiplexed by a demultiplexer, and stored in any convenient format or formats, such as MPEG-1, MPEG-2, MPEG-3, or MPEG-4. It will be clear to those of ordinary skill in the art having the benefit of this disclosure that other formats can be used as well. Such formats are known in the art and will not be discussed in further detail here in the interest of brevity.

An advertising database 113 is operable with the server system 110 and includes one or more advertisements 114 stored therein. In one embodiment, the advertisements comprise video advertisements. One example of an advertisement 114 is a “banner ad” that can be overlayed across content offerings. These banner ads appear on video content such as web pages, movies, videos, and television programs. Another example of an advertisement 114 is an interstitial advertisement that is inserted between portions of the content 109. Another example of an advertisement 114 is a parallel advertisement that is presented to the side of, above, or below, the content 109 while the content is being presented. These examples of advertisements are illustrative only. The advertisements 114 can be static or dynamic.

The advertisements 114 are configured for delivery to user devices 106,107,108 belonging to members of an audience, which in the illustrative embodiment of FIG. 1 is shown as users 103,104,105. The advertisements 114 can include, in addition to the advertising content itself, content descriptive data regarding advertised products and services. This advertising descriptive data may be configured as metadata. The advertisements 114 can be targeted, such that each user received advertising content correlated to their preferences, profiles, usage data, demographics, etc.

In one embodiment, a user 103 selects a content offering to watch by way of its user device 106. The content offering can be sent across the interactive network 112 by way of network equipment that provides the managing, processing, and modulation, as appropriate, for the delivery of the content offering across the interactive network 112 to the user device 106.

The interactive network 112 may be any type of network capable of transferring data electronically, such as, but not limited to, cable networks, the Internet, wireless networks, Telco networks, or satellite networks. For ease of explanation, an illustrative embodiment will employ a cable network. However, it will be clear to those of ordinary skill in the art having the benefit of this disclosure that embodiments are not so limited. Other networks can be used as well.

Content 109 is delivered in accordance with a schedule created by a scheduler 202. The scheduler 202 will operate differently in different environments. However, in each environment the scheduler 202 will be responsible for determining when the content 109 is transmitted to a user 103,104,105.

For instance, the scheduler 202 can schedule content delivery in response to user requests in a pure video-on-demand environment. Alternatively, in broadcast systems, the scheduler 202 can schedule content delivery based upon temporal criteria. For example, Program A can be scheduled as a video offering to be delivered to the user devices 106,107,108 on Sunday at 9 PM. Similarly, Program B may be scheduled to be delivered at 10 PM. Video delivery platforms 203,204,205 transmit the content offerings to the user devices 106,107,108 in accordance with the schedule generated by the scheduler 202.

The server complex 102 may include a control unit 210 or other processing device operable with one or more storage devices 212 and, in one or more embodiments, a database management system 211. The database management system 211 can function as a server or storage device and has appropriate software. The database management system 211 can contain listings or tables of one or more of the following: the content providers, the subscribers, the servers upon which the content is located, the schedules (in a broadcast environment), the orders and purchase history of each subscriber (in a video-on-demand environment), metadata related to the content files, and data regarding the usage or demand of the content.

The database management system 211 can be configured to interact with any of a number of database types depending upon system design and application. For example, in one embodiment the databases can take one of two main forms: relational databases and non-relational databases. Relation databases have enforceable constraints between tables, whereas non-relational databases do not have enforceable constraints between tables. Non-relational databases can be better suited for macro-scale data storage, such as data comprising terabytes to petabytes or more. In some applications, relational databases can be limited in ability to join data across the enforced constraints. One example of a non-relational databases is the Map-Reduce.sup.™ database framework created by Google, Inc. Examples of a relational databases are those manufactured my Oracle, Inc., including their MySql.sup.™ database software, and Microsoft, Inc. in their Access.sup.™ database product.

In one embodiment, an advertising selector 206 is operable within the server complex 102. The advertising selector 206 is configured to select one or more advertisements 114 from the advertisement database 113 for delivery to user devices of members of an audience. For example, if Program A is scheduled as a content offering to be delivered to all user devices 106,107,108 on Sunday at 9 PM, the advertising selector 206 may select a first advertisement 114 to be included with that content offering. The selection can be based upon a variety of factors, including demographic studies with reference to Program A, advertiser requests for advertising placement during Program A, viewership of Program A, and so forth. An advertising manager 207 operable within the server complex 102 is then configured to deliver the advertisement 114 to the user devices 106,107,108 with the content offering.

Whether the content 109 or the advertisement 114 is presented to the user is “trackable” data due to the server complex's ability to interact with the user devices 106,107,108. Said differently, the server complex is able to query the user devices 106,107,108 to extract data regarding content viewed, viewing times, and so forth. In effect, the server complex 102 can track what content a user watches, as well as when the user watches it, by interacting with that user's user device. Accordingly, presentation data can be compiled from presentation responses 116,117,118 that are transmitted from the user devices 106,107,108 back through the interactive network 112 to the server complex 102 in response to queries. For instance, where a user 103,105 has been presented the advertisement 114, the corresponding user device 106,108 can transmit a positive presentation response 116,118 to the server complex 102. Where a user 104 has not been presented the advertisement 114, the user device 107 can transmit a negative presentation response 117. The ratio of positive presentation responses 116,118 to the total number of advertisements initially delivered forms the presentation rate or usage rate.

In one embodiment, a detector 208 is operable within the server complex 102. The detector 208 can be configured to determine whether a predetermined target corresponding to the advertisement 114 is met. As noted above, in one embodiment the target can comprise a presentation or usage rate for a first advertisement 114. In another embodiment, the target can comprise a minimum number of advertisement presentations. In yet another embodiment, the target can comprise a number of advertisement presentations for comparison to a predetermined minimum threshold to determine whether co-mingling data mining operations to find additional content should be executed.

Illustrating by way of example, in one embodiment a particular advertiser may request a campaign to have at least a 40% presentation rate to be successful. In such an embodiment, the usage rate would be 40%. The detector 208 can then be configured to detect whether the usage rate was met by determining or counting the number of devices presenting the advertisement 114 to a user from a usage set of members of the audience who received the advertisement 114 during the first content offering, and comparing the usage rate to the predetermined threshold.

Where a target usage rate is met, the advertiser is content because its goals were correspondingly achieved. The system purveyor is content because the advertising selector 206 has performed its job with successful results. However, when one or more predetermined thresholds or criteria defined for determining success of a campaign are not achieved, embodiments of the present invention offer a co-mingling data mining function configured to determine future content offerings that may be more suited to a particular advertisement offering.

In another embodiment, an advertiser may request a campaign have at least a 40% usage rate with at least a minimum of 10,000 advertisement presentations occurring. In this embodiment, the usage rate would be 40% with an additional requirement of at least 10,000 advertising presentation events. The detector 208 can then be configured to detect whether the usage rate was met by determining or counting advertising presentations from a total number of advertisements delivered during the first content offering. The detector 208 can also be configured to determine whether a minimum number of presentations was achieved by querying the user devices 106,107,108 and receiving presentation responses 116,117,118.

Where both a target usage rate and a minimum threshold of presentations are equaled or exceeded, all is well. The advertiser is content because its goals were met. The system purveyor is content because the advertising selector 206 has performed its job with successful results. Where one of the criteria is not met, embodiments of the present invention provide advantages over prior art systems in that they offer a co-mingling data mining function configured to determine future content offerings that may be more suited to a particular advertisement offering.

In yet another embodiment, the advertiser may simply want a minimum number of advertisement presentations to occur. For example, an advertiser may request a campaign have at least 10,000 advertisement presentations to be successful. The detector 208 can then be configured to detect whether the minimum threshold of advertisement presentations was met by querying the user devices 106,107,108 and counting positive presentation responses 116 of the advertisement 114 during the first content offering.

Where the minimum threshold is met, the advertiser is content because its 10,000 advertisements were not only received, but were additionally presented to users. Where the number of advertising presentations falls below the minimum threshold, the co-mingling data mining function can be configured to determine future content offerings that may be more suited to a particular advertisement offering.

A database-mining engine 209 is operable within the server complex 102. The a database-mining engine, which in one embodiment is operable with an audience demographic database 119 or, additionally, the database management system 211, can be configured to act when any of the following occur, as described above: the usage rate was not met with a particular content offering and advertisement combination; a minimum number of advertisement presentations was not detected with a particular content offering; or where the usage rate was met but the minimum number of advertising presentations was not met with a particular content offering and advertisement combination.

In one embodiment, the database-mining engine 209 can be configured to determine one or more additional content offerings where at least a portion of the usage set of members was co-mingled in the past. Where the usage set of members was sufficiently co-mingled, the database-mining engine 209 can identify the additional content offering and then determine one or more future content offerings for insertion of a particular advertisement.

In one embodiment the database-mining engine 209 is configured to examine a predetermined usage window, such as a window of four months. The database-mining engine 209 accordingly searches for content offerings, perhaps by title, time, channel, genre, or combinations thereof, to find where the highest percentages of the usage group were co-mingled. Thus, if 2000 advertisement presentations occurred in a campaign requiring a minimum threshold of 10,000 presentations, the database-mining engine 209 can be configured to find content offerings where the highest percentages of the 2000-member usage group were co-mingled. The database-mining engine 209, in one embodiment, selects these content offerings as the additional content offerings. Where the content offerings were, for example, television programs, the database-mining engine 209 denotes these programs as potential other offerings for which the advertisement 114 may achieve the target usage rate.

In one embodiment, the database-mining engine 209 can then be configured to identify other additional offerings by analyzing the offerings where the usage group was sufficiently co-mingled and then generating a list of probable times and channels where viewership is likely to occur by viewers having demographics similar to those of the usage group. In one embodiment, this is done in multiple iterations to increase the pool for calculation. For example if a first iteration only returned a population of 500 potential viewers, the database-mining engine 209 could be configured to reanalyze additional content offerings to generate additional times and channels of opportunity for the purposes of increasing the population.

An advertising placement opportunity generator 214 operable within the server complex 102 can be configured to schedule either the initial advertisement or, alternatively, another advertisement selected by the advertising selector 206, for delivery by the advertising delivery manager 207 during at least one of the one or more additional content offerings. Where the identified program is not scheduled for future showings, the database-mining engine 209 may select other programs that correspond to the identified ones to propose as additional content offerings. The selection may be based upon time, channel, title, genre, subject matter, actors, locations, themes, creators, or other factors.

In one embodiment, the server complex 102 can be configured to determine specific identities of the user devices 106,108 delivering positive advertisement presentation responses 116,118. The detector 208 can be configured to perform the identification by detecting a device identifier, which is included in one embodiment in each user device 106,107,108. The device identifiers can be delivered in the up stream presentation response communication. In one embodiment, the advertising placement opportunity generator 214 can be configured to scheduling the advertisements for delivery during the future content offering to devices having unique MAC addresses.

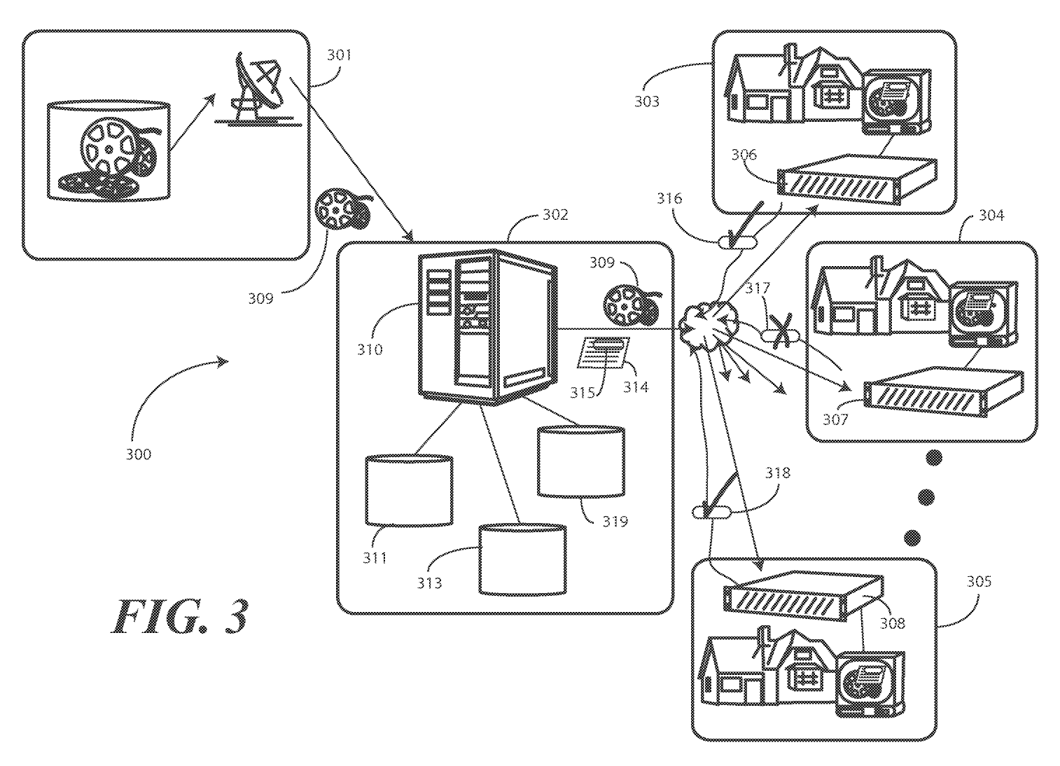

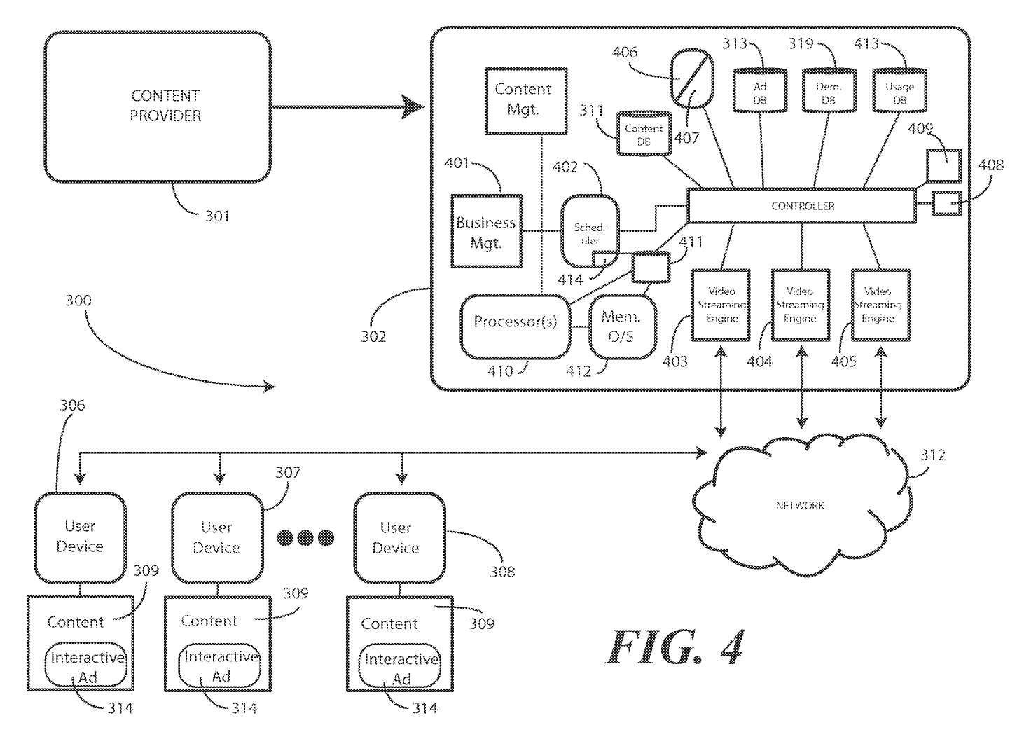

Turning now to FIGS. 3 and 4, illustrated therein is a system 300 for delivering interactive advertising to a target audience in accordance with one or more embodiments of the invention. FIG. 3 illustrates a macro-level view of the system 300, while FIG. 4 includes a block diagram illustrating components of a server complex 302. Many of the components are similar to those shown in FIGS. 1 and 2 above.

The system 300 is configured for delivering video content offerings to one or more users 303,304,304. As with the system (100) of FIG. 1, the system 300 of FIG. 3 can be configured as a video-on-demand system, such as a terrestrial, cable, or satellite video-on-demand system. Alternatively, the system 300 can also be configured as a terrestrial, cable, or satellite television system, or alternatively a wide-area, local-area, or Internet Protocol-based video content delivery system.

The general components of the system 300 include one or more content providers 301, a server complex 302, and one or more users 303,304,305. Each of the users 303,304,305 has a corresponding user device 306,307,308 configured to receive content 309. Examples of suitable user devices 306,307,308 include a television, set-top-box, personal computer, laptop, smartphone, tablet computer, personal digital assistant, handheld computer, cellular telephone, or the like.

The content providers 301 provide content 309 to the server complex 302 for delivery to the user devices 306,307,308. The content 309 can be delivered in various formats across various communication systems. A content receiver (not shown) operable with the server complex 302 receives the content 309. In one embodiment, the server system 310 then stores the content 309 in a content database 311. In another embodiment, the server system 310 simply distributes the content 309 through its network in real time.

An advertising database 313 is operable with the server system 310 and includes one or more advertisements stored therein. In one embodiment, the advertisements comprise interactive advertisements 314 comprising click-through interaction features 315. One example of an advertisement employing a click-through interaction feature is a “banner ad” that can be overlayed across content offerings. When a user clicks on the advertisement, they are taken to additional content associated with the advertisement. For instance, if a banner ad states, “Would you like to know the history of fising?”, clicking “yes” may take you to a video short on the history of fishing. Clicking “no” dismisses the advertisement. In one embodiment, the interactive advertisements 314 are configured for delivery to user devices 306,307,308 belonging to members of an audience, which in the illustrative embodiment of FIG. 3 is shown as users 303,304,305. The interactive advertisements 314 can include, in addition to the advertising content itself, barkers and content descriptive data regarding advertised products and services. This advertising descriptive data may be configured as metadata.

Selected content 309 is delivered in accordance with a schedule created by a scheduler 402. For example, Program A can be scheduled as a video offering to be delivered to the user devices 306,307,308 on Sunday at 9 PM. Similarly, Program B may be scheduled to be delivered at 10 PM. Video delivery platforms 403,404,405 transmit the content offerings to the user devices 306,307,308 in accordance with the schedule generated by the scheduler 402. The content offering can be sent across the interactive network 312 by way of network equipment that provides the managing, processing, and modulation, as appropriate, for the delivery of the content offering across the interactive network 312 to the user device 306.

The server complex 402 may include a control unit 410 or other processing device and, in one or more embodiments, a database management system 411. The database management system 411 can function as a server or storage device and has appropriate software and storage devices 412. The storage devices 412 of the database management system 411 can contain listings or tables of one or more of the following: the content providers, the subscribers, the servers upon which the content is located, the schedules (in a broadcast environment), the orders and purchase history of each subscriber (in a video-on-demand environment), metadata related to the content files, and data regarding the usage or demand of the content.

In one embodiment, an advertising selector 406 is operable within the server complex 400. The advertising selector 406 is configured to select one or more interactive advertisements 314 from an advertisement database 313 for delivery to user devices of members of an audience. For example, if Program A is scheduled as a content offering to be delivered to all user devices 306,307,308 on Sunday at 9 PM, the advertising selector 406 may select a first interactive advertisement 314 to be included with that content offering. The selection can be based upon a variety of factors, including demographic studies with reference to Program A, advertiser requests for advertising placement during Program A, viewership of Program A, and so forth. An advertising manager 407 operable within the server complex 400 is then configured to deliver the interactive advertisement 314 to the user devices 306,307,308 with the content offering. In one embodiment, the interactive advertisement 314 includes a click-through interaction feature 315 described above.

Click-through actions can be counted by receiving click-through responses 316,317,318 that are transmitted from the user devices 306,307,308 back through the interactive network 312 to the server complex 400. For instance, where a user 303,305 wishes to see more about an interactive advertisement 314, the corresponding user device 306,308 can transmit a positive click-through response 316,318 to the server complex 400. Where a user 304 wishes to dismiss an interactive advertisement 314, the user device 307 can transmit a negative click-through response 317. The ratio of positive click-through responses to the total number of interactive advertisements forms the click-through rate.

In one embodiment, a click-through detector 408 is operable within the server complex 400. In one embodiment, the click-through detector 408 can be configured to determine a target click-through interaction usage rate for a first interactive advertisement 314. In another embodiment, the click-through detector 408 can also be configured to determine a total number of click-through interactions. In yet another embodiment, the click-through detector 408 can be configured to determine a number of click-through interaction events for comparison to a predetermined minimum threshold.

Illustrating by way of example, in one embodiment a particular advertiser may request a campaign to have at least a 40% click-through rate to be successful. In such an embodiment, the target click-through rate would be 40%. The click-through detector 408 can then be configured to detect whether the target click-through interaction usage rate was met by determining or counting positive click-through responses from a usage set of members of the audience who use a click-through interaction feature of the first interactive advertisement 314 during the first content offering, and comparing the positive responses to the overall audience.

Where a target click-through rate is met all is well. The advertiser is content because its goals were met. The system purveyor is content because the advertising selector 406 has performed its job with successful results. Embodiments of the present invention offer a co-mingling data mining function configured to determine future content offerings that may be more suited to a particular interactive advertisement when a predetermined criterion indicating an advertisement's initial success is not met. Accordingly, embodiments offer a co-mingling data mining function that works to uncover future content offerings where the target click-through rate will be met or exceeded.

In another embodiment, an advertiser may request a campaign have at least a 40% click-through rate with at least a minimum of 10,000 click-through interactions occurring. In this embodiment, the target click-through rate would be 40% with an additional requirement of an audience of at least 25,000 potential “clickers.” The click-through detector 408 can then be configured to detect whether the target click-through interaction usage rate was met by determining or counting positive click through responses from a usage set of members of the audience who use a click-through interaction feature of the first interactive advertisement 314 during the first content offering. The click-through detector 408 can also be configured to determine whether a minimum number of click-through interactions was achieved.

Where both a target click-through rate and a minimum click requirement are met, all is well. Where one of the criteria is not met, embodiments of the present invention provide a co-mingling data mining function configured to determine future content offerings that may be more suited to a particular interactive advertisement. Accordingly, embodiments offer a co-mingling data mining function that works to uncover future content offerings where the target click-through rate and minimum click requirement will be met or exceeded.

In yet another embodiment, the click-through detector 408 may itself calculate the target click-through rate based upon advertising or system parameters. For example, an advertiser may request a campaign have at least 10,000 click-through usage interactions to be successful. A minimum threshold for this example would be 10,000 click-through usage interactions. The click-through detector 408 can then be configured to detect whether the minimum threshold of click-through interaction occurrences was met by determining or counting positive click through responses of the first interactive advertisement 314 during the first content offering.

Where the minimum threshold is met, the advertiser is content because its 10,000 click-through user interactions were received. Where the number of click-through usage interactions falls below the minimum threshold, embodiments of the present invention provide a co-mingling data mining function configured to determine future content offerings that may be more suited to a particular interactive advertisement. Accordingly, embodiments offer a co-mingling data mining function that works to uncover future content offerings where the target click-through interactions will be met or exceeded.

The database-mining engine 409 is operable within the server complex 400. The a database-mining engine, which in one embodiment is operable with an audience demographic database 319 or, additionally, the database management system 411, can be configured to act when any of the following occur: the target click-through interaction usage rate was not met with a particular content offering and interactive advertisement combination; a minimum number of click-through interactions was not detected with a particular content offering and interactive advertisement combination; or where the click-through interaction usage rate was met but the minimum number of click-through interactions was not met with a particular content offering and interactive advertisement combination. In one embodiment, the database-mining engine 409 can be configured to determine one or more additional content offerings where at least a portion of the usage set of members was co-mingled in the past. Where the usage set of members was sufficiently co-mingled in the past, the database mining engine 409 can identify the additional content offering and then determine one or more future content offerings corresponding to the one or more additional content offerings for insertion of the interactive advertisement.

This is best explained by way of an illustrative example. Presume that Advertiser A wishes to roll out a new national interactive campaign employing interactive advertisements 314 that include click-through interaction features 315. For instance, the click-through interaction feature 315 can be a “click-to-long” feature where positively responding causes additional content corresponding to the interactive advertisement 314 to be delivered to a user device. Now presume that Advertiser A requests the scheduler 402 to schedule their interactive advertisement 314 to run on Sunday on Channel X during an automobile race. They desire to get a 40% click-through rate, and the click-through detector 408 is configured accordingly. Now presume that when the interactive advertisement is delivered with the content offering, the click-through detector 408 determined that only a 20% click-through rate is achieved.

When this occurs, i.e., when the target click-through rate is not achieved, the database-mining engine 409 can be configured to determine additional content offerings where at least a portion of the usage set of members was co-mingled in a variety of ways by working with the content database 311, the demographic database 319, a content usage or demand database 413, the database management system 411, or combinations thereof. In one embodiment, the database-mining engine 409 can be configured to determine the one or more additional content offerings by selecting an additional content offering where a maximum number of members of the usage set of members were viewing. For instance, if the database-mining engine 409 determines that there are ten content offerings within a predetermined usage window, such as the previous month, where the usage group had co-mingled viewers, and one of the ten had the most co-mingled members of the usage group, the database-mining engine 409 can be configured to select that content offering.

In another embodiment, the database-mining engine 409 can be configured to determine the one or more additional content offerings by selecting a plurality of additional content offerings where at least a predetermined minimum number of members of the usage set of members were viewing. For example, the database-mining engine 409 may be configured to determine where at least 60% of the usage group was viewing to identify additional content offerings.

In another embodiment, the database-mining engine 409 can be configured to determine the predetermined minimum of members of the usage set of members by selecting a viewership of at least one of one or more content offerings. For example, the database-mining engine 409 can be configured to select all content offerings occurring within the predetermined usage window where more than 50% of the usage group was viewing.

Continuing the example from above, in one embodiment the database-mining engine 409 is configured to examine a predetermined usage window of four months. The database-mining engine 409 accordingly searches for content offerings, perhaps by title, time, channel, genre, or combinations thereof, to find where the highest percentages of the usage group were co-mingled. Thus, for the 20% of the audience who responded with positive click-through responses when the interactive advertisement 314 was first delivered, the database-mining engine 409 can be configured to find content offerings where the highest percentages of the usage group formed by the 20% of the audience were co-mingled. The database-mining engine 409, in one embodiment, selects these content offerings as the additional content offerings. Where the content offerings were, for example, television programs, the database-mining engine 409 denotes these programs as potential other offerings for which the interactive advertisement 314 may achieve the target click-through rate.

In one embodiment, the database-mining engine 409 can then be configured to identify other additional offerings by analyzing the offerings where the usage group was sufficiently co-mingled and then generating a list of probable times and channels where viewership is likely to occur by viewers having demographics similar to those of the usage group. In one embodiment, this is done in multiple iterations to increase the pool for calculation. For example if a first iteration only returned a population of 500 potential viewers, the database-mining engine 409 could be configured to reanalyze additional content offerings to generate additional times and channels of opportunity for the purposes of increasing the population.

Presume that the result of the database-mining engine's analysis was that 70% of the usage group was co-mingled during a program on the history of trout fishing. Where there were additional showings of this program, the program itself can be identified as an additional content offering. Accordingly an advertising placement opportunity generator 414 operable within the server complex 400 can be configured to schedule either the initial interactive advertisement or, alternatively, another interactive advertisement selected by the advertising selector 406, for delivery by the advertising delivery manager 407 during at least one of the one or more additional content offerings.

Where the identified program is not scheduled for future showings, the database-mining engine 409 may select other programs that correspond to the identified ones to propose as additional content offerings. The selection may be based upon time, channel, title, genre, subject matter, actors, locations, themes, creators, or other factors. In this illustration, if the history of trout fishing was not scheduled for a future showing, the database-mining engine 409 may select a show on how fishing tackle is made, since both shows have the genre of fishing in common The advertising placement opportunity generator 414 can then be configured to schedule either the original interactive advertisement or another interactive advertisement selected by the advertising selector 406 for delivery by the advertising delivery manager 407 during at least one of the one or more additional content offerings. Subsequent click-through rates, interactions, or combinations thereof can then be delivered to the business management module 401.

In one embodiment, the server complex 400 can be configured to determine specific identities of the user devices 306,308 delivering positive click-through responses 316,318. The click-through detector 408 can be configured to perform the identification, as a device identifier is included, in one embodiment, in the click-through response 316,318. The device identifiers can be delivered in the up stream click-through response.

The example set forth in the preceding paragraphs outlines the operation of the server complex 400 when a target usage interaction rate was not met. The steps carried out can also be performed when either a minimum click-through interaction rate was met but a predetermined minimum number of click-through interactions was not achieved, or alternatively where a predetermined number of click-through interactions was not met regardless of click-through interaction usage rate. The steps to find additional content would be the same, with only the trigger mechanism for performing the steps to find additional content changing in each exemplary embodiment.

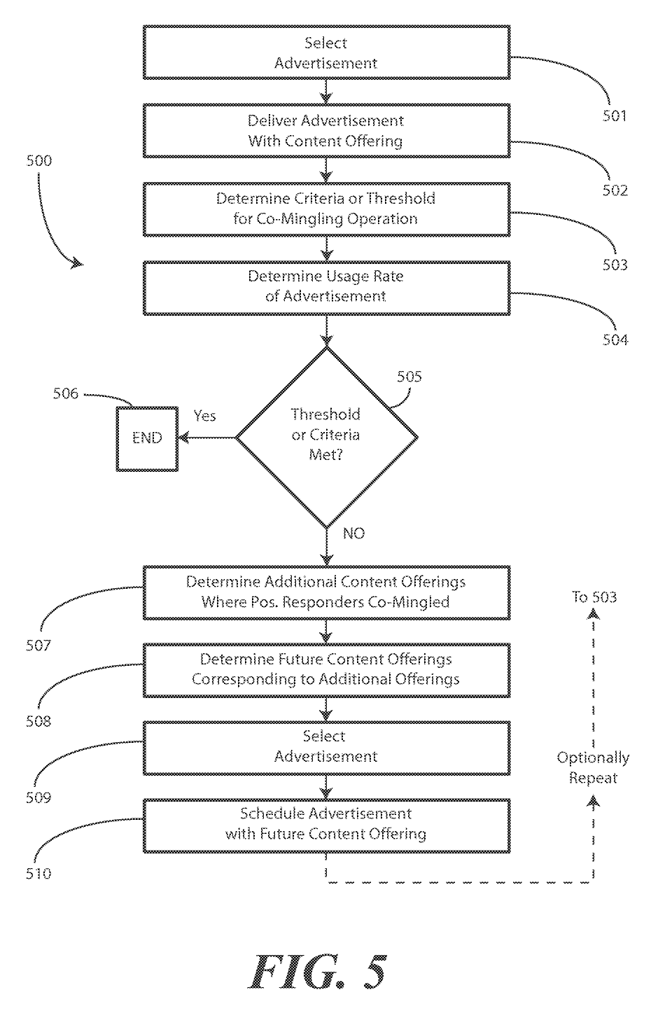

Turning now to FIG. 5, illustrated therein is one method 500 for delivering generic advertising in accordance with one or more embodiments of the invention. The method steps shown in FIG. 5 correspond to some of the functions of the server complex (102) described above because the method steps are suitable for coding as executable instructions capable of execution by the control unit (210) and other components of the server complex (102) to effect the steps of the method.

At step 501, an advertisement for delivery to members of an audience is selected. In one embodiment, the selection can be made by an advertising selector (206) of the server complex (102). At step 502, the advertisement is delivered to user devices of each of the members of the audience. In one embodiment, an advertising delivery manager (207) can be configured to deliver the advertisement during a content offering. Examples of content offerings include television programs, movies, videos, user-requested content, and so forth.

At step 503, a predetermined criterion or minimum threshold corresponding to advertisement usage is selected. This can be a rate of advertisement presentations, a number of advertisement presentations, or combinations thereof. This can be determined from an advertiser's request, or may alternatively be selected by a purveyor of a content delivery system.

At step 504, usage is determined. In one embodiment, this is determined by querying user devices (106,107,108) and receiving presentation responses (116,117,118). Additionally, this step 504 can include determining positive advertisement presentation responses (116,118) and negative advertisement presentation responses (117). The audience members responsible for positive advertisement presentation responses (116,118) can be used to define a usage set of members for co-mingling operations.

At decision 505, a determination of whether the usage rate is met by comparing the number of advertisement presentations to the predetermined criteria or threshold established at step 502. In one embodiment, this step 505 optionally includes determining which of the user devices presented the advertisement during the first content offering. For example, this can include determining a unique Internet identifier, such as an IP address, telephone number, MAC address, etc., for each of the user devices presenting the advertisement.

In one embodiment, where the usage rate was met or exceeded, the process stops at step 506. At step 507, a co-mingling determination of one or more additional content offerings is performed by comparing one or more co-mingling criteria against a threshold. This can include examining viewership concentration of members of the user group, a minimum number of viewers from the user group receiving other content offerings, or a maximum viewer selection from all co-mingled content offerings occurring within a predetermined usage window. For example, in one embodiment, this involves reviewing a predetermined usage window and finding other content offerings where at least a certain amount of the usage group were viewing those content offerings. In one embodiment a database-mining engine (209) can be configured to determine where at least a predetermined number of the usage set exceeds a predetermined viewing threshold. As described above, this can mean finding additional content offerings where at least a certain number of members from the usage in excess of a viewership threshold were watching. Where, for example, the viewership threshold is at least 40% of the user group, a content offering where 48% of the user group watching would be selected, while another content offering where only 20% of the user group were watching would not be selected.

In another embodiment, step 507 includes determining one or more additional offerings that constitute a maximum of all available offerings where at least two members of the usage set were viewing. For example, if the predetermined usage window was four weeks, step 507 can include determining all the content offerings during those four weeks where at least two members of the usage group were co-mingled, and then selecting the content offering having the maximum co-mingling.

At step 508, the method 500 determines when future content offerings corresponding to the selected additional content offerings will occur. As noted above, in one embodiment this can be determining when the additional offerings will be shown in the future. In another embodiment, this step 508 involves selecting future offerings that correspond to the additional offerings selected. The correspondence can be based on title, time, channel, genre, actors, subject matter, or other factors.

At step 509, the method 500 selects another advertisement for inclusion with the future content offering selected at step 508. In one embodiment, step 509 can simply be selecting the previously used advertisement. In another embodiment, step 509 can include the selection of a different interactive advertisement that corresponds to the initial interactive advertisement. The correspondence can be based upon subject matter, click-through content, advertiser, advertised information, or other factors.

At step 510, the new advertisement is scheduled for delivery during the future content offering selected at step 508. Step 510 can include scheduling the new advertisement for at least delivery to the user devices having the identified device identifiers, which in one embodiment are MAC addresses. Once the new advertisement is delivered with the future content offering, some steps of the method 500 can optionally repeat.

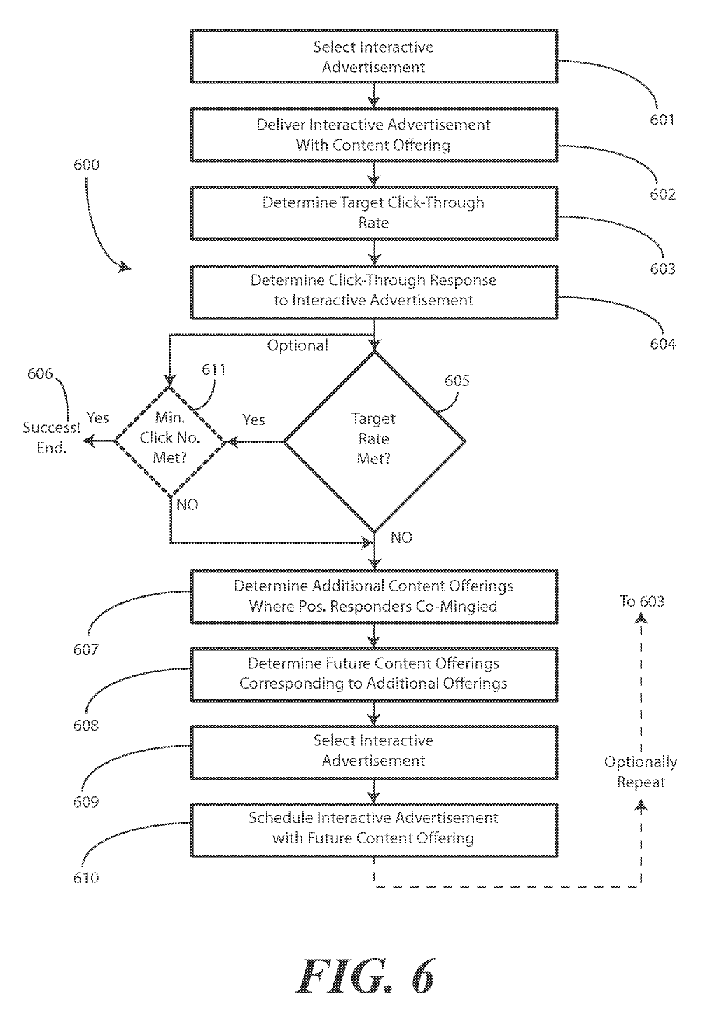

Turning now to FIG. 6, illustrated therein is one method 600 for delivering interactive advertising selected for a target audience in accordance with one or more embodiments of the invention. The method steps shown in FIG. 6 correspond to some of the functions of the server complex (302) described above because the method steps are suitable for coding as executable instructions capable of execution by the control unit (410) and other components of the server complex (302) to effect the steps of the method.

At step 601, an interactive advertisement for delivery to members of an audience is selected. In one embodiment, the selection can be made by an advertising selector (406) of the server complex (400). In one embodiment, the interactive advertisement selected includes a click-through interaction feature.

At step 602, the interactive advertisement is delivered to user devices of each of the members of the audience. As previously described, the delivery can occur across a network. In one embodiment, an advertising delivery manager (407) can be configured to deliver the interactive advertisement during a content offering. Examples of content offerings include television programs, movies, videos, user-requested content, and so forth.

At step 603, a target is selected. In one embodiment, the a target click-through rate is selected. This can be determined from an advertiser's request, or may alternatively be selected by a purveyor of a content delivery system, such as a broadcast system or a video-on-demand system. The target click-through rate represents a ratio of positive click-through usage interactions to a total number of members of the audience. In another embodiment, a target click-through rate and a minimum number of click-through interactions is determined. In yet another embodiment, a minimum threshold of click-through interactions is determined independent of target click-through usage rate.

At step 604, usage is determined. In one embodiment, the actual click-through rate is determined. In one embodiment, a click-through detector (408) is configured to determine the click-through rate by monitoring positive click-through responses (316,318) and negative click-through responses (317). The audience members responsible for positive click-through responses (316,318) are used to define a usage set of members who use the click-through interaction feature present in the interactive advertisement. In one embodiment, the click-through rate is determined during the content offering with which the interactive advertisement is associated. In another embodiment, both the actual click-through rate and a number of click-through interactions is determined. In yet another embodiment, a number of click-through interactions is determined independent of click-through response rate.

At decision 605, a determination of whether the target click-through rate, a minimum number of click-through interactions, or combinations thereof, for the first content offering, was achieved. For example, in one embodiment, the click-through detector (408) can be configured to make this decision. In one embodiment, this step 605 optionally includes determining which of the user devices received the interactive advertisement used the click-through interaction feature during the first content offering. For example, this can include determining a unique device identifier, such as an IP address or MAC address, for each of the user devices using the click-through interaction feature.

In one embodiment, where the target click-through rate is achieved, the process stops at step 606. Achieving the click-through rate means that a satisfactory correlation between the audience and the advertisement has been achieved. Accordingly, the campaign was a success.

One with benefit of this disclosure will appreciate that even when the correlation between content audience and advertising is high, the content itself may be less than impressive. Accordingly, the audience may be small. Illustrating by example, if only ten people watch a particular show, a 40% click-through interaction rate is achieved when only four people execute click-through operations. Thus, in one embodiment an optional minimum participant decision is made at optional decision 611. At decision 611, despite the target-click through rate being achieved, a second check is performed to determine whether a minimum number of click-through interactions was achieved. Where it was, the advertiser is assured of both quality content and high correlation with advertising. Accordingly, the process ends at step 606. However, where the target click-through rate was not met as determined at decision 605, or alternatively where the target click-through rate was met and the minimum requirement for click-through interactions was not met as determined at decision 611, the method 600 proceeds to step 607.

One of ordinary skill in the art will also recognize that some advertisers simply want to ensure that a minimum number of click-through interactions was received. Accordingly, in one embodiment, decision 605 is bypassed along an optional branch arriving at decision 611. In this embodiment, a minimum participant interaction number is compared to a threshold at decision 611. Said differently, decision 611 determines whether a minimum number of click-through interactions was achieved regardless of usage rate. Where it was, the advertiser is assured of reaching its goal. Accordingly, the process ends at step 606. However, where the minimum requirement for click-through interactions was not met as determined at decision 611, the method 600 proceeds to step 607.

At step 607, a co-mingling determination of one or more additional content offerings is performed by comparing one or more co-mingling criteria against a threshold. This can include examining viewership concentration of members of the user group, a minimum number of viewers from the user group receiving other content offerings, or a maximum viewer selection from all co-mingled content offerings occurring within the predetermined usage window. For example, in one embodiment, this involves reviewing a predetermined usage window and finding other content offerings where at least a certain amount of the usage group were viewing those content offerings. For example, in one embodiment a database-mining engine (409) can be configured to determine where at least a predetermined number of the usage set exceeds a predetermined viewing threshold. As described above, this can mean finding additional content offerings where at least a certain number of members from the usage in excess of a viewership threshold were watching. Where, for example, the viewership threshold is at least 40% of the user group, a content offering where 48% of the user group watching would be selected, while another content offering where only 20% of the user group were watching would not be selected.

In another embodiment, step 607 includes determining one or more additional offerings that constitute a maximum of all available offerings where at least two members of the usage set were viewing. For example, if the predetermined usage window was four weeks, step 607 can include determining all the content offerings during those four weeks where at least two members of the usage group were co-mingled, and then selecting the content offering having the maximum co-mingling.

At step 608, the method 600 determines when future content offerings corresponding to the selected additional content offerings will occur. As noted above, in one embodiment this can be determining when the additional offerings will be shown in the future. In another embodiment, this step 608 involves selecting future offerings that correspond to the additional offerings selected. The correspondence can be based on title, time, channel, genre, actors, subject matter, or other factors.

At step 609, the method 600 selects another interactive advertisement for inclusion with the future content offering selected at step 608. The interactive advertisement selected at step 609 can include another click-through user interaction feature, but does not have to include such a feature. In one embodiment, step 609 can simply be selecting the previously used interactive advertisement. In another embodiment, step 609 can include the selection of a different interactive advertisement that corresponds to the initial interactive advertisement. The correspondence can be based upon subject matter, click-through content, advertiser, advertised information, or other factors.

At step 610, the new interactive advertisement is scheduled for delivery during the future content offering selected at step 608. Where step 605 included determining which of the user interaction devices used the click-through interaction feature, step 610 can include scheduling the new interactive advertisement for at least delivery to the user devices having the identified device identifiers, which in one embodiment are MAC addresses.

Once the new interactive advertisement is delivered with the future content offering, some steps of the method 600 can optionally repeat. For example, when the schedule determined at step 610 is executed, the method 600 may optionally repeat step 603 and determine another target click-through rate for the new interactive advertisement. Where the new target click-through rate is again missed as detected at step 604 and determined at decision 605, the method 603 can again perform steps 607-610 to determine additional future content offering opportunities from the new click-through responses detected at step 604.

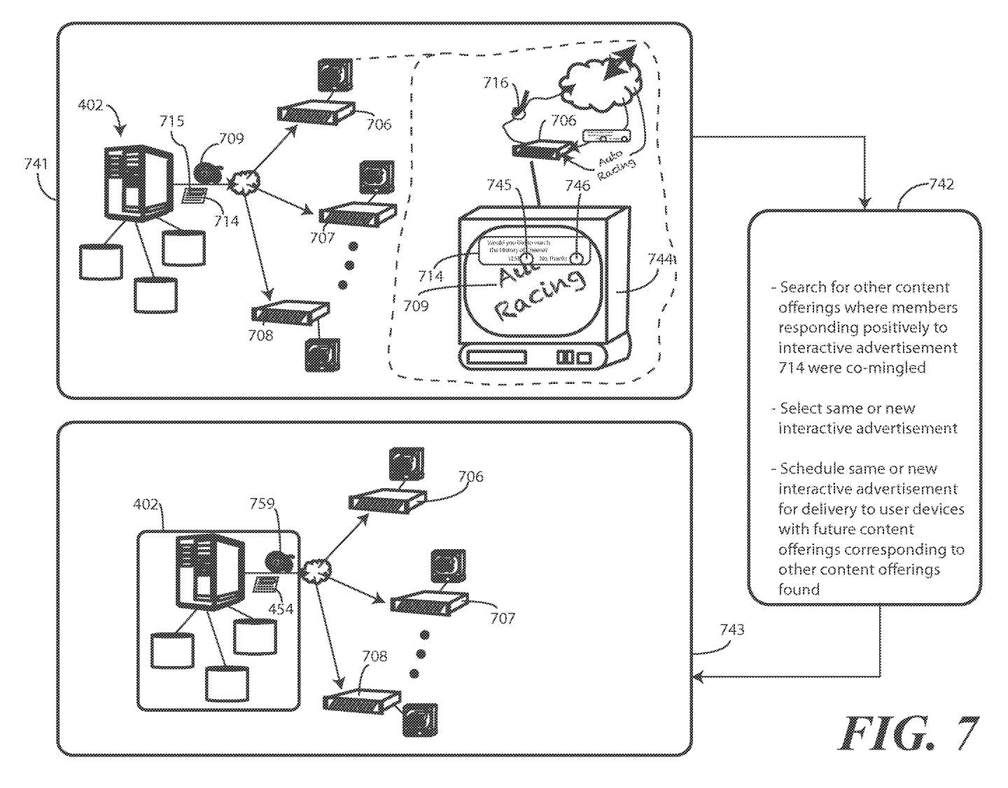

Turning now to FIG. 7, the various steps of the method (600) are illustrated with another exemplary use case. Note that FIG. 7 illustrates the use of interactive advertisements. However, the common steps found in the method (500) of FIG. 5 and the method (600) of FIG. 6, which are shown in FIG. 7, are equally applicable to generic advertisements. The use of interactive advertisements is slightly more complex, and is therefore being used as an illustrative embodiment. Note also that the use cases set forth in this disclosure are examples with which the various apparatus components and method steps may be more readily understood, and should not be construed as limiting the various embodiments described herein. For example, the illustrative embodiment of FIG. 7 centers around whether a target usage rate was met. However, as described above, the co-mingling operations used to find additional content described herein can also be triggered by a usage rate being met but a predetermined number of interactions not being met, or by a predetermined number of interactions not being met regardless of usage rate.

At block 741, the server complex 700 delivers a first content offering 709 and a first interactive advertisement 714 to the user devices 706,707,708 belonging to an audience. In one embodiment, the first interactive advertisement 714 includes one or more click-through interaction features 715. The server system 710, by way of the modules (similar to those shown in FIG. 4) that are operable therein, determines a first click-through target rate for the first interactive advertisement 714 and stores it in memory.

The interactive advertisement 714 appears as an overlay on the content offering presented on a monitor 744 that is operable with a user device 706. The click-through interaction feature 715 is shown as including a positive selection 745 and a negative selection 746. The user can select the positive selection 745 to view additional content related to the interactive advertisement 714. Alternatively, the user can select the negative selection 746 to dismiss the interactive advertisement. The user of monitor 744 has made a positive selection 716, which is transmitted back to the server complex 700. Each user does the same thing. All the positive selections are tallied and are used to define a user group. The server complex 700 then determines whether the target click-through rate was achieved by comparing the number of members in the usage group to the target click-through rate.

Where it was not, the server complex 700 at block 742 goes back in time for a predetermined usage window and reviews content offerings and viewership records stored in various databases. The server complex searches for times and channels, in one embodiment, where the highest ratios of members of the usage group being co-mingled. In one embodiment, this includes identifying user devices that were “on” the same times and channels. In one embodiment, this includes returning an identified list of co-mingled members of the usage group by returning a list of device identifiers, which in one embodiment are MAC addresses, and a time window. In one embodiment, this is done in multiple iterations.

Block 742 then determines in what additional content offerings the co-mingled members of the usage group may be interested. For example, block 742 may return information indicating the co-mingled members of the usage group tend to watch a particular channel at a particular time on Tuesday and Thursday evenings. At block 743, a new interactive advertisement 759 is then delivered to the user devices 706,707,708 at this newly selected time.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for delivering advertising selected for a target audience to the target audience, comprising:
determining whether a predetermined criterion associated with an advertisement selected for delivery to user devices of members of an audience, delivered to the user devices across a network during a first content offering, is achieved with the audience during the first content offering; and
where the predetermined criterion was not met:
performing a co-mingling determination of one or more additional content offerings that occurred within a predetermined usage window meeting a co-mingling criterion meeting or exceeding a predetermined threshold where a plurality of members of a usage group viewed the one or more additional content offerings;
determining when a future content offering corresponding to the one or more additional content offerings will occur;
selecting another advertisement; and
scheduling the another advertisement for delivery during the future content offering.

2. The method of claim 1, wherein the advertisement comprises an interactive advertisement comprising a click-through interaction feature.

3. The method of claim 2, wherein the predetermined criterion comprises a target click-through interaction usage rate.

4. The method of claim 3, further comprising detecting with a click-through detector whether the target click-through interaction usage rate was met by determining a usage set of members of the audience who use the click-through interaction feature during the first content offering.

5. The method of claim 4, wherein the another advertisement comprises another interactive advertisement.

6. The method of claim 5, wherein the another interactive advertisement comprises another click-through user interaction feature.

7. The method of claim 6, wherein the interactive advertisement and the another interactive advertisement are the same.

8. The method of claim 1, wherein the co-mingling criterion comprises a maximum viewership of the usage group selected from all content offerings within the predetermined usage window where at least two members of the usage group received content.

9. The method of claim 1, wherein the co-mingling criterion comprises a predetermined concentration of the usage group of members viewing the one or more additional content offerings.

10. The method of claim 1, wherein the co-mingling criterion comprises a predetermined minimum number of members of the usage group of members viewing the one or more additional content offerings.

11. The method of claim 4, further comprising determining which of the user devices used the click-through interaction feature during the first content offering.

12. The method of claim 11, wherein the determining which of the user devices used the click-through interaction feature during the first content offering comprises determining unique MAC addresses for each of the which of the user devices.

13. The method of claim 12, wherein the scheduling the another advertisement for delivery during the future content offering comprises scheduling the another advertisement for delivery to devices having each of the unique MAC addresses.

14. The method of claim 12, further comprising determining another target click-through interaction usage rate for another usage set of members for the another advertisement.

15. The method of claim 14, further comprising:
performing, with a database mining engine and an audience demographic database, another co-mingling determination of at least one other content offering that occurred within another predetermined usage window where at least another number of the another usage set of members exceeding another determined threshold viewed the at least one other content offering;
determining when another future content offering corresponding to at least one content offering will occur;
selecting a third interactive advertisement; and
scheduling the third interactive advertisement for delivery during the another future content offering.

16. A system for delivering advertising selected for a target audience to the target audience, comprising:
an advertising selector configured to select one or more advertisements for delivery to user devices of members of an audience;
an advertising delivery manager configured to deliver the one or more advertisements to the user devices during content offerings;
a detector configured to determine whether one or more criteria are met for a first advertisement by the audience during a first content offering;
a database mining engine, operable with an audience demographic database, and configured to, when the one or more criteria are not met not met, to determine one or more additional content offerings where at least a portion of a usage group of members was co-mingled, and to then determine one or more future content offerings corresponding to the one or more additional content offerings; and
an advertising placement opportunity generator configured to schedule another advertisement selected by the advertising selector for delivery by the advertising delivery manager during at least one of the one or more additional content offerings.

17. The system of claim 16, wherein the one or more advertisements comprise one or more interactive advertisements.

18. The system of claim 17, wherein the one or more interactive advertisements each comprise one or more click-through interaction features.

19. The system of claim 18, wherein the one or more criteria comprise a minimum target click-through interaction usage rate.

20. The system of claim 18, wherein the detector comprises a click-through detector configured to determine a target click-through interaction usage rate for a first interactive advertisement by the audience during the first content offering, and to detect whether the target click-through interaction usage rate was met by determining a usage set of members of the audience who use a click-through interaction feature of the first interactive advertisement during the first content offering.

21. The system of claim 20, wherein the another advertisement comprises another interactive advertisement.

22. The system of claim 21, wherein the database mining engine is configured to determine the one or more additional content offerings by selecting an additional content offering where a maximum number of members of the usage set of members were viewing.

23. The system of claim 21, wherein the database mining engine is configured to determine the one or more additional content offerings by selecting a plurality of additional content offerings where at least a predetermined minimum number of members of the usage set of members were viewing.

24. The system of claim 23, wherein the database mining engine is configured to determine the at least a predetermined minimum of members of the usage set of members by selecting a viewership of at least one of one or more content offerings.

25. The system of claim 21, further comprising a device identifier configured to identify user devices responsible for use of the click-through interaction feature of the first interactive advertisement during the first content offering.

26. The system of claim 21, wherein at least one of the content offerings comprises a television program.

27. A method for delivering advertising selected for a target audience to the target audience, comprising:
selecting an advertisement for delivery to user devices of members of an audience;
delivering the advertisement to the user devices across a network during a first content offering;
determining a usage rate for the audience during the first content offering; and
where the usage rate was not met:
performing a co-mingling determination of one or more additional content offerings that occurred within a predetermined usage window meeting a co-mingling criterion meeting or exceeding a predetermined threshold where a plurality of members of a usage group viewed the one or more additional content offerings;
determining when a future content offering corresponding to the one or more additional content offerings will occur;
selecting another advertisement; and
scheduling the another advertisement for delivery during the future content offering.

28. The method of claim 27, wherein the advertisement comprises an interactive advertisement comprising a click-through interaction feature.

29. The method of claim 28, wherein the usage rate comprises a target click-through interaction rate.

30. The method of claim 29, further comprising detecting with a click-through detector whether the target click-through interaction rate was met by determining a usage set of members of the audience who use the click-through interaction feature during the first content offering and detecting with the click-through detector whether a minimum number of click-through interactions was met.

31. The method of claim 30, wherein the performing occurs only where the target click-through interaction rate was met, but where the minimum number of click-through interactions was not met.

32. The method of claim 31, wherein the another advertisement comprises another interactive advertisement.

33. The method of claim 28, wherein the usage rate comprises a minimum number of user devices received the advertisement.

34. The method of claim 33, wherein the determining the usage rate comprises determining unique MAC addresses for each of the minimum number of user devices.

35. The method of claim 34, wherein the scheduling the another advertisement for delivery during the future content offering comprises scheduling the another advertisement for delivery to devices having each of the unique MAC addresses.

36. A method for delivering advertising selected for a target audience to the target audience, comprising:
selecting an interactive advertisement comprising a click-through interaction feature for delivery to user devices of members of an audience;
delivering the interactive advertisement to the user devices across a network during a first content offering;
determining a minimum threshold of click-through interactions for the audience during the first content offering;
detecting with a click-through detector whether the minimum threshold of click-through interactions met by determining how many of a usage group of members of the audience use the click-through interaction feature during the first content offering; and
where the minimum threshold of click-through interactions was not achieved:
performing a co-mingling determination of one or more additional content offerings that occurred within a predetermined usage window meeting a co-mingling criterion meeting or exceeding a predetermined threshold where a plurality of members of the usage group viewed the one or more additional content offerings;
determining when a future content offering corresponding to the one or more additional content offerings will occur;
selecting another interactive advertisement; and
scheduling the another interactive advertisement for delivery during the future content offering.

37. A method for delivering advertising selected for a target audience to the target audience, comprising:
selecting an advertisement for delivery to user devices of members of an audience;
delivering the advertisement to the user devices across a network during a first content offering;
determining a minimum threshold of user devices for the audience during the first content offering;
detecting with a detector whether a number of the user devices presenting the advertisement to a user exceeds the minimum threshold of user devices; and
where the minimum threshold of user devices is not exceeded by the number of the user devices presenting the advertisement:
performing a co-mingling determination of one or more additional content offerings that occurred within a predetermined usage window meeting a co-mingling criterion meeting or exceeding a predetermined threshold where a plurality of members of a usage group viewed the one or more additional content offerings;
determining when a future content offering corresponding to the one or more additional content offerings will occur;
selecting another advertisement; and
scheduling the another interactive advertisement for delivery during the future content offering.
